(19) United States
(12) Patent Application Publication
(10) Pub. No.: US 2017/0130669 A1
(43) Pub. Date: May 11, 2017

(54) ALLOY POWDER COMPOSITION FOR CONNECTING ROD AND METHOD OF MANUFACTURING CONNECTING ROD USING THE SAME

(71) Applicant: HYUNDAI MOTOR COMPANY, Seoul (KR)

(72) Inventors: Sung Min KIM, Gimpo-si (KR); Hak Soo KIM, Seoul (KR)

(21) Appl. No.: 15/081,227

(22) Filed: Mar. 25, 2016

(30) Foreign Application Priority Data
Nov. 5, 2015 (KR) 10-2015-0155325

(51) Int. Cl. F02F 7/00; C22C 38/04; C22C 38/00; C21D 9/00; B22F 5/00; B22F 1/00; B22F 3/16; B22F 3/00; B22F 3/17; B22F 3/24; C22C 38/20; C21D 1/18

(52) U.S. Cl. CPC F02F 7/0085; C22C 38/20; C22C 38/04; C22C 38/002; C21D 9/0068; C21D 1/18; B22F 1/0003; B22F 3/16; B22F 3/004; B22F 3/17; B22F 3/24; B22F 5/008; B22F 2003/248; B22F 2301/35; B22F 2998/10

(57) ABSTRACT

An alloy powder composition for a connecting rod includes 0.5 to 0.8% by weight of carbon (C), 0.8 to 1.2% by weight of copper (Cu), 1.6 to 2.0% by weight of chrome (Cr), 0.4% by weight or less but greater than zero (0) of manganese (Mn), 0.2% by weight or less but greater than 0 of sulfur (S), a remainder of iron (Fe), and other unavoidable impurities, based on 100% by weight of the alloy powder composition.

### CROSS-REFERENCE TO RELATED APPLICATION

This application claims the benefit of priority to Korean Patent Application No. 10-2015-0155325, filed on Nov. 5, 2015 in the Korean Intellectual Property Office, the disclosure of which is incorporated herein by reference.

### TECHNICAL FIELD

The present disclosure relates to an alloy powder composition for a connecting rod having improved mechanical properties such as strength, and a method of manufacturing the connecting rod in which a bolt hole can be easily drilled.

### BACKGROUND

In a conventional process of manufacturing a connecting rod, a quenching/tempering (Q/T) process for increasing strength is performed after forging. In such a conventional manufacturing process, complex processes including first processing for completing a connecting rod, a heat treatment process such as quenching/tempering (Q/T), and subsequent second processing are additionally required. In addition, the manufacturing process should be performed twice due to increase in hardness caused by the heat treatment. In addition, deformation and bending of a connecting rod due to quenching may occur.

The above disclosed background art has been provided to aid in understanding of the present disclosure and should not be interpreted as a conventional technology known to a person having ordinary skill in the art.

### SUMMARY

The present disclosure has been made in view of the above problems, and an aspect of the present inventive concept provides an alloy powder composition for a connecting rod having superior mechanical properties such a superior strength, and a method of manufacturing the connecting rod in which drilling a bolt hole can be easily processed.

In accordance with an exemplary embodiment in the present disclosure, an alloy powder composition for a connecting rod includes 0.5 to 0.8% by weight of carbon (C), 0.8 to 1.2% by weight of copper (Cu), 1.6 to 2.0% by weight of chrome (Cr), 0.4% by weight or less (but, not 0) of manganese (Mn), 0.2% by weight or less (but, not 0) of sulfur (S) , a remainder of iron (Fe), and other unavoidable impurities, based on 100% by weight of the alloy powder composition.

A weight ratio of chrome (Cr) to copper (Cu) may be 1.33 to 2.30.

In accordance with another exemplary embodiment in the present disclosure, a method of manufacturing a connecting rod includes: molding a preliminary molded product by injecting an alloy powder including 0.5 to 0.8% by weight of carbon (C), 0.8 to 1.2% by weight of copper (Cu), 1.6 to 2.0% by weight of chrome (Cr), 0.4% by weight or less but greater than zero (0) of manganese (Mn), 0.2% by weight or less but greater than 0 of sulfur (S) , a remainder of iron (Fe) , and other unavoidable impurities based on 100% by weight of the alloy powder into a mold, and then pressing by a press. The preliminary molded product is sintered and forged. The forged preliminary molded product is re-heated and cooled. The cooled preliminary molded product is then tempered.

A weight ratio of chrome (Cr) to copper (Cu) in the alloy powder may be 1.33 to 2.30.

In the re-heating, a temperature for the re-heating may be 880 to 950° C. and the re-heating may be performed in a sintering furnace under a hydrogen atmosphere.

In the cooling, cooling may be performed at a rate of 2 to 3° C./s.

The tempering may be performed at 450 to 600° C.

### BRIEF DESCRIPTION OF THE DRAWINGS

The above and other objects, features and other advantages of the present disclosure will be more clearly understood from the following detailed description taken in conjunction with the accompanying drawings.

FIG. 1 illustrates an image of a connecting rod that is subjected to cooling control according to an embodiment in the present disclosure.

FIG. 2 illustrates an image of minute copper and cementite tissue crystallized according to an embodiment in the present disclosure.

FIG. 3 is a graph illustrating a buckling evaluation result of the connecting rod.

### DETAILED DESCRIPTION

Reference will now be made in detail to the exemplary embodiments in the present disclosure, examples of which are illustrated in the accompanying drawings. The same reference numbers will be used throughout the drawings to refer to the same or like parts.

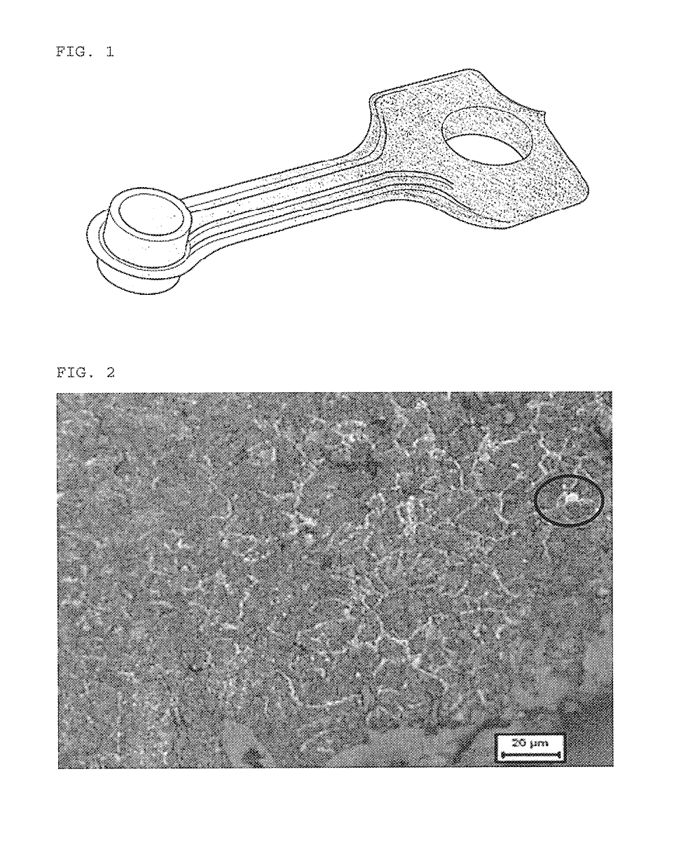

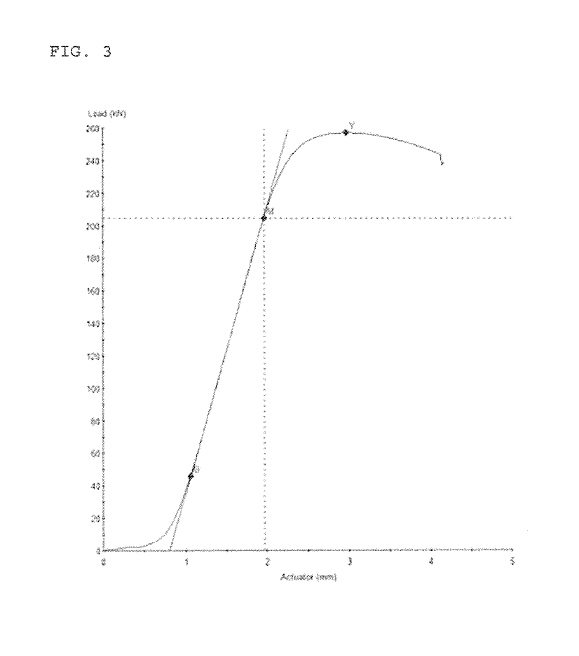

FIG. 1 illustrates an image of a connecting rod that is subjected to cooling according to an embodiment in the present disclosure, and FIG. 2 illustrates an image of minute copper and cementite tissue crystallized according to an embodiment in the present disclosure.

An alloy powder composition for a connecting rod according to an exemplary embodiment in the present disclosure includes 0.5 to 0.8% by weight of carbon (C), 0.8 to 1.2% by weight of copper (Cu), 1.6 to 2.0% by weight of chrome (Cr), 0.4% by weight or less but greater than zero (0) of manganese (Mn) , 0.2% by weight or less but greater than 0 of sulfur (S), a remainder of iron (Fe), and other unavoidable impurities, based on 100% by weight of the alloy powder composition. Hereinafter, ingredients of steel in the alloy powder composition for a connecting rod according to the present disclosure are described in detail.

Carbon (C): 0.5 to 0.8%

Carbon (C) may increase strength and facilitates heat treatment. When carbon (C) is added in an amount of less than 0.5%, mechanical properties such strength decrease. In addition, when carbon (C) is added in an amount of greater than 0.8%, brittleness increases and coarse cementite is generated on a surface of the connecting rod. Accordingly, the amount of carbon (C) is limited to 0.05 to 0.15%.

Copper (Cu): 0.8 to 1.2%

Copper (Cu) may enhance hardenability. When copper (Cu) is added in an amount of less than 0.8%, mechanical properties may decrease. In addition, when copper (Cu) is added in an amount of greater than 1.2%, processability may decrease. Accordingly, the amount of copper (Cu) is limited to 0.10 to 1.0%.

Chrome (Cr): 1.6 to 2.0%

Chrome (Cr) may increase strength and quenching properties. When chrome (Cr) is added in an amount of less than 1.6%, mechanical properties may decrease. When chrome (Cr) is added in an amount of greater than 2.0%, the risk that an oxide is generated on a surface of the connecting rod during sintering increases. Accordingly, the amount of chrome (Cr) is limited to 1.6 to 2.0%.

Manganese (Mn) : 0.4% or less: (but, not 0)

Manganese (Mn) may decrease toxicity of an element present in steel. When manganese (Mn) is added in an amount of greater than 0.4%, it bonds with sulfur to form MnS. When MnS is excessively formed, fatigue strength increases. Accordingly, the amount of manganese (Mn) is limited to 0.4% or less

Sulfur (S): 0.2% or less (but, not 0)

Sulfur (S) may bond with manganese to form an inclusion. When sulfur (S) is added in an amount of greater than 0.2%, it bonds with manganese to form MnS. When MnS is excessively formed, fatigue strength increases. Accordingly, the amount of sulfur (S) is limited to 0.2% or less.

In the alloy powder composition for a connecting rod according to the present disclosure, a weight ratio of chrome (Cr) to copper (Cu) is 1.33 to 2.30.

Copper (Cu) and chrome (Cr) are elements which affect hardenability increase. The expression “hardenability” means performance of steel hardened into martensite through quenching, as ease of hardening upon quench-hardening of iron steel.

However, when a weight ratio of chrome (Cr) to copper (Cu) is less than 1.33 due to a high amount of copper (Cu) or a small amount of chrome (Cr), i.e., when a weight ratio of chrome (Cr) to copper (Cu) is 0.9 as shown in FIG. 2, cementite tissue excessively occurs on a surface of the connecting rod due to crystallization of the minute copper, and thus, fatigue strength is decreased.

When a weight ratio of chrome (Cr) to copper (Cu) is greater than 2.30 due to a small amount of copper (Cu) or a high amount of chrome (Cr), i.e., when a weight ratio of chrome (Cr) to copper (Cu) is 3.0 as confirmed in Comparative Example 5 of Table 1 below, yield strength is remarkably decreased, compared to the case in which a weight ratio of chrome (Cr) to copper (Cu) is 1.3 to 2.30.

In addition, when molding is performed after sintering, forging pressure may increase and ductility may decrease. Accordingly, moldability may be entirely deteriorated.

Results for a tensile test for each material in an example and comparative examples are summarized in Table 1 below. Here, properties before cooling are numerically compared.

TABLE 1

| | Ingredients (% by weight) | | | | | | | | Mechanical properties | | |
|---|---|---|---|---|---|---|---|---|---|---|---|
| | | | | | | | | Fe and | Yield | Tensile | |
| | | | | | | | | unavoidable | strength | strength | Hardness |
| Classification | C | Cu | Cr | Mo | V | Mn | S | impurities | (MPa) | (MPa) | (HRC) |
| Example | 0.7 | 1 | 1.8 | — | — | 0.2 | 0.1 | Remainder | 1013.5 | 1266.8 | 42 |
| Comparative | 0.7 | — | 1.5 | — | 0.2 | 0.2 | 0.1 | Remainder | 756 | 1050 | 38 |
| Example 1 | | | | | | | | | | | |
| Comparative | 0.7 | 1 | — | 0.85 | — | 0.2 | 0.1 | Remainder | 618.7 | 888.3 | 29 |
| Example 2 | | | | | | | | | | | |
| Comparative | 0.5 | 1 | 1.5 | 0.2 | — | 0.2 | 0.1 | Remainder | 711.7 | 1091 | 36.9 |
| Example 3 | | | | | | | | | | | |
| Comparative | 0.5 | — | 3.0 | 0.5 | — | 0.2 | 0.1 | Remainder | 806 | 996.3 | 40.4 |
| Example 4 | | | | | | | | | | | |
| Comparative | 0.5 | 1 | 3.0 | 0.5 | — | 0.2 | 0.1 | Remainder | 766.7 | 1204.5 | 41 |
| Example 5 | | | | | | | | | | | |

When the Example and Comparative Example 1 are compared, it can be confirmed that Comparative Example 1 additionally contains V instead of Cu. In addition, it can be confirmed that Cr is added in an amount of less than 1.6%. Accordingly, it can be confirmed that, in Comparative Example 1, yield strength and tensile strength are remarkably lower, and hardness is also lower than that of Example.

When the Example and Comparative Example 2 are compared, it can be confirmed that Comparative Example 2 does not contain Cr, but additionally contains Mo. Due to such a difference, Comparative Example 2 exhibits remarkably lower yield strength, tensile strength, and hardness, compared to Example.

When the Example and Comparative Example 3 are compared, it can be confirmed that Comparative Example 3 additionally contains Mo and includes Cr in an amount of less than 1.6%. Accordingly, it can be confirmed that Comparative Example 3 exhibits remarkably lower yield strength, tensile strength, and hardness, compared to the Example.

When the Example and Comparative Example 4 are compared, it can be confirmed that Comparative Example 4 does not contain Cu, but additionally includes Mo. In addition, it can be confirmed that Comparative Example 4 includes Cr in an amount of greater than 2.0%. Due to such differences, Comparative Example 4 exhibits remarkably lower yield strength and tensile strength, compared to the Example. Hardness of Comparative Example 4 is however similar to that of the Example.

When the Example and Comparative Example 5 are compared, it can be confirmed that Comparative Example 5 additionally contains Mo and includes Cr in an amount of greater than 2.0%. Accordingly, it can be confirmed that, in Comparative Example 5, yield strength is remarkably lower and tensile strength and hardness are similar to those of the Example.

A method of manufacturing a connecting rod according to the present disclosure includes molding a preliminary molded product by injecting an alloy powder including 0.5 to 0.8% by weight of carbon (C), 0.8 to 1.2% by weight of copper (Cu), 1.6 to 2.0% by weight of chrome (Cr), 0.4% by weight or less of manganese (Mn) (but, not zero (0)), 0.2% by weight or less (but, not 0) of sulfur (S) , a remainder of iron (Fe) , and other unavoidable impurities based on 100% by weight of the alloy powder into a mold, and then by pressing by a press. The preliminary molded product is sintered. The sintered preliminary molded product is then forged. The forged preliminary molded product is re-heated and cooled. The cooled preliminary molded product is then tempered.

A weight ratio of chrome (Cr) to copper (Cu) in the alloy powder may be 1.33 to 2.30.

In the re-heating, a temperature for the re-heating may be 880 to 950° C., and the re-heating may be performed in a sintering furnace under a hydrogen atmosphere.

In the cooling, cooling may be performed at a rate of 2 to 3° C./s.

In addition, the tempering may be performed at 450 to 600° C.

In the molding, a metal powder having the above composition is inserted into a mold, followed by pressing by the press at room temperature. A pressure is 4 to 6 tons/cm² is used. The preliminary molded product having the same shape as the connecting rod is manufactured. A small end, a big end, and a rod are integrally formed.

In the sintering, to accomplish chemical bonding between powders, the preliminary molded product, which is weakly bonded, is sintered using hydrogen and nitrogen gases at an 1100 to 1140° C. in a sintering furnace. In the sintering, powder particles are bonded when a powder-type molded product is heated, and thus are hardened into a molded shape. Accordingly, the strength of the preliminary molded product increases after the sintering.

Next, in the forging, the sintered preliminary molded product is input to a die for forge-pressing, and molding pressure is added thereto to increase the overall density of the preliminary molded product. Here, the molding pressure is 200 to 600 ton/cm².

In the re-heating, the preliminary molded product that is forged is heated again to prevent crystal grains from becoming coarsened during air cooling after the forging, thus decreasing strength. The re-heating may be performed again at 880 to 950° C. in a sintering furnace under a hydrogen atmosphere.

When the re-heating temperature is less than 880° C., austenite tissue is not 100% transformed, and thus, might not be 100% formed into martensite tissue during cooling. In addition, when the re-heating temperature is greater than 950° C., crystal grains become coarse, and thus, properties such as strength may decrease.

In the cooling, the preliminary molded product heated is cooled to enhance strength by inducing transformation into martensite tissue. The cooling may be performed while controlling a cooling rate to 2 to 3° C./s. While performing the cooling control, cooling is performed to 400° C. or less.

Since the volume of each part of the preliminary molded product differs, each part has a different cooling rate during control. The small end and the rod with a small volume have relatively high cooling rates, and thus, strengths thereof increase due to formation into martensite tissue. In a case of the big end with a large volume, a cooling rate thereof is relatively low, and thus, tempering effects autonomously occur. Accordingly, a hardness value, which enables a bolt hole drilling process, is exhibited.

When the manufacturing processing is facilitated in this manner, deformation is reduced even when splitting is performed using fracture splitting, and thus, conventional fracture splitting may be used instead of a processing division method in which a laser notch is used. Accordingly, manufacturing costs are reduced.

When the control cooling rate is less than 2° C./s, complete deformation into martensite tissue is impossible, and an austenite remainder is formed. Accordingly, mechanical properties such as strength may decrease. On the other hand, when the cooling control rate greater than 3° C./s, the preliminary molded product is bent due to rapid cooling and a hardness value of the big end may increase. Accordingly, drilling and polishing become difficult, and thus, processing costs increase.

In Table 2, mechanical properties, such as buckling strength, of connecting rods made of the alloy powder composition for the connecting rod according to the present invention are compared varying only controlled cooling rates thereof. The alloy powder composition includes 0.7% of carbon (C), 1% of copper (Cu), 1.8% of chrome (Cr), 0.4% or less of manganese (Mn), 0.2% or less of sulfur (S), and a remainder of iron (Fe).

TABLE 2

| | Controlled | | | | |
|---|---|---|---|---|---|
| | cooling | Yield | Tensile | Buckling | Bending |
| | rate | strength | strength | strength | degree |
| | (° C./s) | (MPa) | (MPa) | (KN) | (mm) |
| Supercooling | 3.5 | 1350 | 1525 | 170 | 3.2 |
| specification | | | | | |
| Controlled cooling | 3 | 1274.9 | 1457.1 | 205 | 0.7 |
| specification 1 | | | | | |
| Controlled cooling | 2 | 1191.7 | 1408.6 | 191 | 0.5 |
| specification 2 | | | | | |
| General cooling | 1 | 1013.5 | 1266.8 | 160 | 0.1 |
| specification | | | | | |

Buckling is a phenomenon wherein a connecting rod is bent by a compression load applied thereto. Buckling strength a load applied to a connecting rod before the connecting rod buckles. In addition, a bending degree is measured based on a bottom surface of a big end of a connecting rod. In particular, the bending degree may be found through Equation (1) below:

(Step of upper side of small end−step of lower side of small end)/2 Equation (1)

In the case of the supercooling specification, yield strength and tensile strength increase. However, a controlled cooling rate is high, and thus, a bending degree is large due to rapid cooling. When bending occurs, buckling strength of the connecting rod is decreased as shown in Table 2. In addition, in the case of the general cooling specification, a controlled cooling rate is low, and thus, a bending degree is small. However, overall yield strength, tensile strength, and buckling strength are low.

Referring to FIG. 3 illustrating a graph to evaluate buckling of the connecting rod, it can be confirmed that buckling strength linearly increases at a certain value or more, but linear buckling strength increase does not occur at about 2 mm or more and buckling strength rather decreases at about 3 mm or more.

In the tempering, the preliminary molded product that is cooled is heated within a constant temperature range. The tempering may be performed at 450 to 600° C. to provide tenacity to the preliminary molded product and lower a hardness value thereof.

When the tempering is performed at less than 450° C., tenacity of the preliminary molded product becomes deficient and a hardness value increases. Accordingly, processing becomes difficult. On the other hand, when the tempering is performed at greater than 600° C., mechanical properties such as strength of the preliminary molded product may decrease.

In the case of a connecting rod manufactured according to the method of manufacturing the connecting rod, mechanical properties such as yield strength, tensile strength, and core hardness are excellent, compared to a connecting rod which is subjected to Q/T treatment after steel-forging.

By controlling a cooling rate to 2 to 3° C./s instead of rapidly cooling the entirety of the connecting rod by heat treatment such as quenching according to the conventional method, the small end and rod are relatively rapidly cooled due to small volumes thereof, and the big end is relatively slowly cooled due to a large volume thereof. Accordingly, autonomous tempering effects may be exhibited.

Mechanical properties of a connecting rod manufactured by the method of manufacturing the connecting rod according to the present disclosure and a connecting rod subjected to Q/T treatment after steel-forging are compared. Results are summarized in Table 3 below.

TABLE 3

| | Yield | Tensile | | | |
|---|---|---|---|---|---|
| | strength | strength | Core hardness (HRC) | | |
| Classification | (MPa) | (MPa) | Big end | Rod | Small end |
| Q/T treatment | 961.4 | 1024.6 | 32.7 | 33.3 | 33.1 |
| after steel forging | | | | | |
| Cooling control | 1191.7 | 1408.6 | 38.6 | 45.8 | 46.1 |
| after sinter-forging | | | | | |

As shown in Table 3, it can be confirmed that the connecting rod manufactured by the method of manufacturing the connecting rod according to the present disclosure has enhanced yield strength, tensile strength, and core hardness, compared to the connecting rod subjected to Q/T treatment after steel-forging. In addition, it can be confirmed that, in the connecting rod manufactured by the method of manufacturing the connecting rod according to the present disclosure, core hardness of the big end is lower than core hardness of the small end or the rod. Accordingly, a hardness value of the big end is relatively low, and thus, processing is facilitated.

As is apparent from the above description, the present disclosure provides an alloy powder composition for a connecting rod. By controlling a weight ratio of copper (Cu) to chrome (Cr), which affect increase of hardenability, in the alloy powder composition, enhancement of mechanical properties such as fatigue strength and tensile strength may be anticipated.

In addition, it can be anticipated that, by performing cooling while controlling a cooling rate according to the method of manufacturing a connecting rod using an alloy powder of the present disclosure, entirely superior mechanical properties are exhibited, and at the same time, a big end with a high volume has superior moldability.

Although the exemplary embodiments in the present disclosure have been disclosed for illustrative purposes, those skilled in the art will appreciate that various modifications, additions, and substitutions are possible, without departing from the scope and spirit of the invention as disclosed in the accompanying claims.

What is claimed is:

1. An alloy powder composition for a connecting rod, the alloy powder composition comprising: 0.5 to 0.8% by weight of carbon (C), 0.8 to 1.2% by weight of copper (Cu), 1.6 to 2.0% by weight of chrome (Cr), 0.4% by weight or less but greater than zero (0) of manganese (Mn), 0.2% by weight or less but greater than (0) of sulfur (S), a remainder of iron (Fe), and other unavoidable impurities, based on 100% by weight of the alloy powder composition.

2. The alloy powder composition according to claim 1, wherein a weight ratio of chrome (Cr) to copper (Cu) is 1.33 to 2.30.

3. A method of manufacturing a connecting rod, the method comprising:
molding a preliminary molded product by injecting an alloy powder comprising 0.5 to 0.8% by weight of carbon (C), 0.8 to 1.2% by weight of copper (Cu), 1.6 to 2.0% by weight of chrome (Cr), 0.4% by weight or less but greater than zero (0) of manganese (Mn), 0.2% by weight or less but greater than 0 of sulfur (S) , a remainder of iron (Fe) , and other unavoidable impurities based on 100% by weight of the alloy powder into a mold, and then pressing by a press;
sintering the preliminary molded product;
forging the sintered preliminary molded product;
re-heating the forged preliminary molded product;
cooling the re-heated preliminary molded product; and
tempering the cooled preliminary molded product.

4. The method according to claim 3, wherein a weight ratio of chrome (Cr) to copper (Cu) in the alloy powder is 1.33 to 2.30.

5. The method according to claim 3, wherein, in the re-heating, the re-heating is performed in a sintering furnace under a hydrogen atmosphere at a temperature for the re-heating is 880 to 950° C.

6. The method according to claim 3, wherein, in the cooling, cooling is performed at a rate of 2 to 3° C./s.

7. The method according to claim 3, wherein the tempering is performed at 450 to 600° C.
